(19) United States
(12) Patent Application Publication
(10) Pub. No.: US 2011/0141635 A1
(43) Pub. Date: Jun. 16, 2011

(54) Thermally protected GFCI

(76) Inventor: Steven D. Fabian, Port Jefferson, NY (US)

(21) Appl. No.: 12/653,239

(22) Filed: Dec. 10, 2009

(51) Int. Cl. H02H 3/00; H02H 5/04

(52) U.S. Cl. 361/45; 361/93.8

(57) ABSTRACT

An electrical device having thermal overload protection detects an abnormal temperature of the current carrying conductors, and causes a current imbalance so that a ground fault circuit interrupter (GFCI) triggers, thereby cutting off current flow and preventing thermal overload.

### BACKGROUND OF THE INVENTION

The present invention relates to a ground fault circuit interrupter (GFCI) having protection against overheating.

A Ground Fault Circuit Interrupt (GFCI) monitors the balance of current passing through two wires that are carrying power, typically referred to as a line conductor and a neutral conductor. The current on the line conductor can be thought of as electrical charge going downstream, from the source to the load, while the current on the neutral conductor can be thought of as going upstream.

As long as the difference between current on the conductors stays within a given range, normally 5 ma, the GFCI does not interfere with normal operation. If the sensed current does not remain in balance, or within the given range, the GFCI interrupts current flow, thereby causing power to be shut off to the load. GFCIs are required by the National Electrical Code (NEC) in bathroom and kitchen outlets, i.e., where water is possible.

It has been proposed to use thermal protection for a receptacle in combination with a GFCI-protected power control panel. However, such proposals do not operate in a safe manner.

Accordingly, there is need for an improved way to provide thermal protection for a GFCI.

### SUMMARY OF THE INVENTION

In accordance with an aspect of this invention, there is provided an electrical device having thermal overload protection. A current difference detector measures the difference in current between a line conductor and a neutral conductor. A control circuit prevents current flow on the line and neutral conductors when the measured current differences exceeds a current difference threshold. A temperature detection circuit detects a temperature of at least one of the line and neutral conductors and causes a current difference exceeding the current difference threshold when the detected temperature exceeds a temperature threshold.

The electrical device may be a circuit breaker, an electrical receptacle, an electrical plug, a power strip or a receptacle adaptor.

In accordance with another aspect of this invention, there is provided a method of providing thermal overload protection in an electrical device. The difference in current between a line conductor and a neutral conductor is measured. Current flow on the line and neutral conductors is prevented when the measured current differences exceeds a current difference threshold. A temperature of at least one of the line and neutral conductors is detected, and when the detected temperature exceeds a temperature threshold, a current difference exceeding the current difference threshold is caused.

### BRIEF DESCRIPTION OF THE DRAWINGS

FIG. 1 is a schematic diagram of a prior art GFCI and thermal interrupt;

FIG. 2 is a schematic diagram of a first embodiment of a prior art thermal interrupt;

FIG. 3 is a schematic diagram of a second embodiment of a prior art thermal interrupt;

FIG. 4 is a schematic diagram of a GFCI with thermal protection according to the present invention, used in a circuit breaker;

FIG. 5A is a schematic diagram showing details of the thermally protected GFCI in FIG. 4;

FIG. 5B is a schematic diagram showing a variation of the thermally protected GFCI in FIG. 4;

FIG. 6 shows the thermally protected GFCI used in a receptacle and in a plug;

FIG. 7 shows the thermally protected GFCI used in a power strip;

FIG. 8 shows the thermally protected GFCI used in a receptacle adaptor;

FIG. 9 is a schematic diagram of another embodiment of a GFCI with thermal protection, used in a circuit breaker;

FIG. 10 shows the alternative thermally protected GFCI used in a receptacle and in a plug;

FIG. 11 shows the alternative thermally protected GFCI used in a power strip; and

FIG. 12 shows the alternative thermally protected GFCI used in a receptacle adaptor;

### DETAILED DESCRIPTION

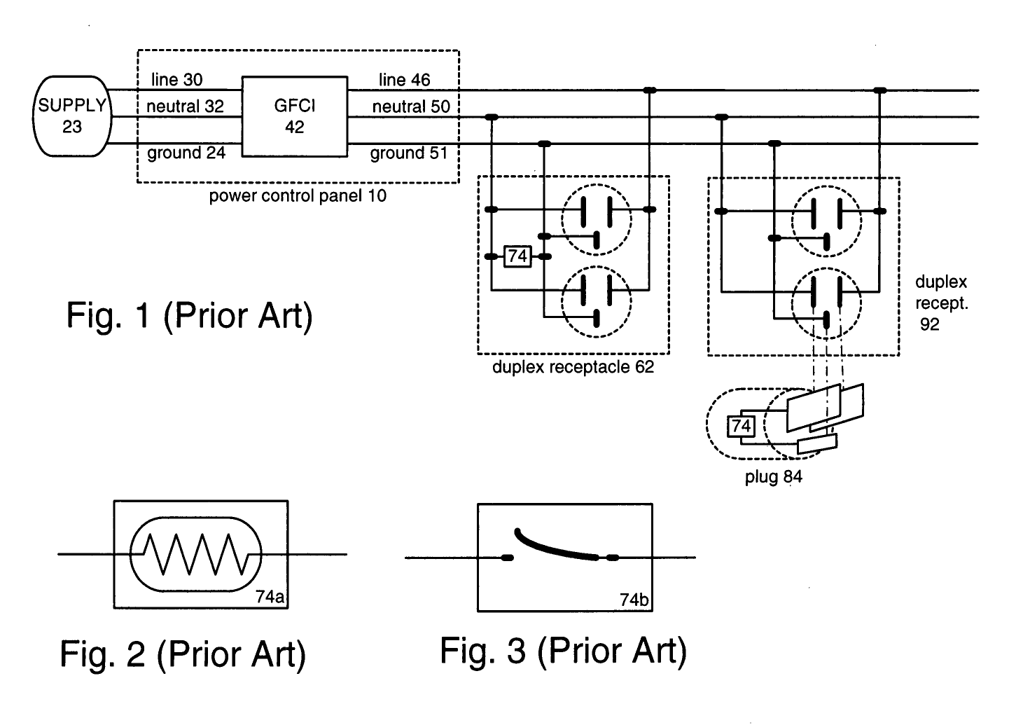

U.S. Pat. No. 3,872,355 (Klein) relates to a fire protection circuit and device. FIG. 1 shows supply 23 connected to power control panel 10, which in turn is connected to duplex receptacles 62 and 92. Plug 84 is inserted into one of the outlets of duplex receptacle 92.

Power control panel 10 includes ground fault circuit interrupter (GFCI) 42. Line conductor 30, neutral conductor 32 and ground conductor 24 are each connected between power supply 23 and GFCI 42. GFCI 42 measures the current difference between line conductor 30 and neutral conductor 32, and when this exceeds a predetermined threshold, interrupts the current flow. Line conductor 46, neutral conductor 50 and ground conductor 51 are on the output (downstream) side of GFCI 42.

Duplex receptacle 62 includes two three-prong outlets. Each of the three prong receiving portions is connected to a respective one of line conductor 46, neutral conductor 50 and ground conductor 51. Thermal detector 74 is located in duplex receptacle 62, connected between a first conductor connected to neutral conductor 50 and a second conductor connected to ground conductor 51.

Thermal detector 74 may be a negative temperature coefficient (NTC) thermistor, as shown in FIG. 2, or a bimetal as shown in FIG. 3.

Thermal detector 74 is normally at a high impedance, so current essentially does not flow through detector 74. However, when the temperature exceeds a predetermined threshold, thermal detector 74 goes from a high impedance to a low impedance, so that current flows between the first and second conductors, simulating a ground fault on neutral conductor 50.

In an alternate configuration, plug 84 is inserted into an outlet of duplex receptacle 92, which is a conventional duplex receptacle. However, plug 84 has thermal detector 74 connected between its neutral blade and its ground pin.

Klein notes that alternatively, thermal detector 74 can be placed between the line (hot) conductor and the ground conductor, however, this is frowned upon by the various electrical codes.

UL and ANSI safety conventions prohibit circuits that function to deliberately create a fault to ground. Klein's technique of diverting current to ground intentionally creates a fault, which is unsafe and prohibited by safety conventions.

Two embodiments of an electrical device having thermal overload protection will now be discussed. The electrical device detects an abnormal temperature of the current carrying conductors, and causes a current imbalance so that a ground fault circuit interrupter (GFCI) triggers, thereby cutting off current flow and preventing thermal overload.

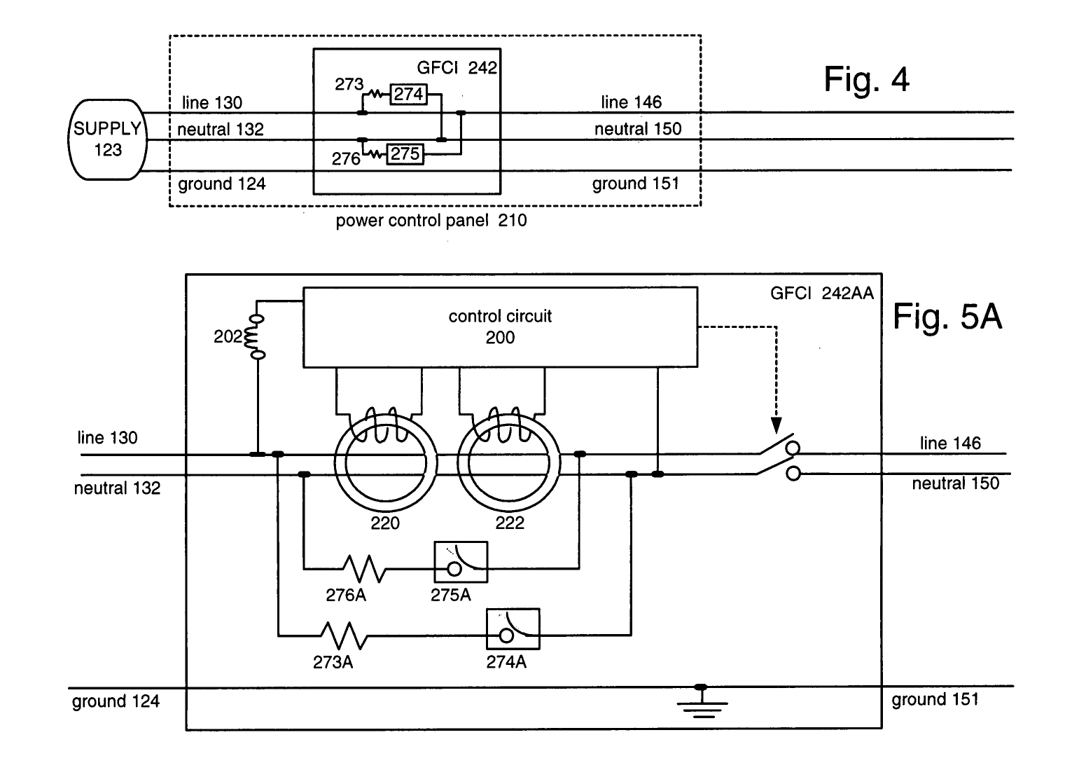

FIG. 4 is a schematic diagram of a GFCI with thermal protection used in a circuit breaker. Power supply 123 is connected to power control panel 210, which in turn is connected to downstream power consuming devices (not shown). Power control panel 210 includes ground fault circuit interrupter (GFCI) 242. Line conductor 130, neutral conductor 132 and ground conductor 124 are each connected between power supply 123 and GFCI 242. GFCI 242 measures the current difference between line conductor 130 and neutral conductor 132, and when this exceeds a predetermined threshold, such as a threshold in the range 5 mA-30 mA, stops the current flow. Line conductor 146, neutral conductor 150 and ground conductor 151 are on the output (downstream) side of GFCI 242. GFCI 242 includes thermal detectors 274, 275.

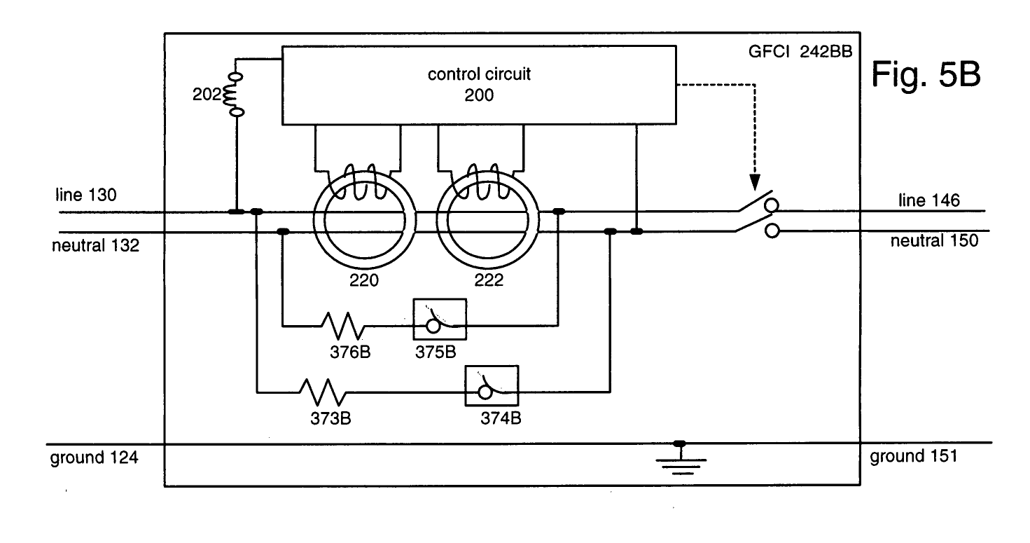

FIG. 5A shows details of thermally protected GFCI 242AA. As in a conventional GFCI, line conductor 130 and neutral conductor 132 pass through differential transformer 220 and ground/neutral transformer 222. Solenoid 202 is coupled between line conductor 130 and control circuit 200. Transformers 220 and 222 convey current level information to control circuit 200, and when the current imbalance exceeds a predetermined threshold, control circuit 200 disconnects the switches at the output side that are coupled to line conductor 146 and neutral conductor 150, and causes a button (not shown) to pop.

Resistor 273A is coupled between line conductor 130 and thermal detector 274A. Thermal detector 274A is coupled between resistor 273A and neutral conductor 150.

Resistor 276A is coupled between neutral conductor 132 and thermal detector 275A. Thermal detector 275A is coupled between resistor 276A and line conductor 146.

Resistors 273A, 276A have different resistances, to prevent current flow even if thermal detectors 274A, 275A switch at the same time. For instance, resistor 276A may have a value of 10 kOhms and resistor 273A may have a value of 20 kOhms, or vice-versa, or any other suitable values.

Thermal detectors 274A, 275A are identical units, and may be any suitable thermal detector, such as a bimetal, thermal reed switch or negative temperature coefficient (NTC) resistor. For manufacturability, a self-resetting bimetal is preferred. In some embodiments, a non-resetting bimetal is used so that an electrician must replace the triggered GFCI and investigate the problem. The bimetal in its normal open state does not have current passing therethrough and does not affect the operation of GFCI 242.

Use of two thermal detectors enables monitoring of four critical terminals: the line input, the line output, the neutral input and the neutral output. It will be understood that while conductors 130, 132, 146, 150 are present primarily to conduct current, they also conduct heat.

When the temperature sensed by bimetal 274A or 275A reaches a predetermined threshold, such as a temperature in the range 75° C.-200° C. depending on the bimetal selected, the bimetal snaps closed, diverting part of the current from one of conductors 146, 150 to one of conductors 130, 132, forcing an increased current difference between conductors 130, 132 that is sensed by control circuit 200 which in turn activates solenoid 202 and interrupts the current flow to the load and to all downstream elements such as receptacles (not shown).

The bimetal trigger threshold is chosen to be above normal operating temperature but below the temperature at which electrical materials are adversely affected such as plastic melting, i.e., in the range 75° C.-200° C.

Diverting current does not create a fault, so the configuration of FIG. 5 is safe. However, diverting current causes control circuit 200 to detect a current imbalance so thermal protection is achieved.

FIG. 5B shows details of a variation of thermally protected GFCI 242BB. FIG. 5B is similar to FIG. 5A, and for brevity, only differences are discussed.

Resistor 373B is coupled between line conductor 130 and thermal detector 374B. Thermal detector 374B is coupled between resistor 373B and neutral conductor 150.

Resistor 376B is coupled between neutral conductor 132 and thermal detector 375B. Thermal detector 375B is coupled between resistor 376B and line conductor 146.

Resistors 373B, 376B have identical resistances, such as a value of 10 kOhms, or any other suitable values.

Thermal detectors 374B, 375B are identical units, and may be any suitable thermal detector. For instance, thermal detectors 374B, 375B may be bimetals in a normal closed position, so that the currents fed back from the output of transformers 220, 222 to the respective inputs of transformers 220, 222 are equal. When overheating occurs, one of the bimetals opens before the other due to differences in heat propagation time and/or components not being perfect identical, causing detection of a current imbalance and triggering the GFCI to stop current flow. Instead of a bimetal, a thermal fuse or NTC resistor or positive temperature coefficient (PTC) resistor may be used.

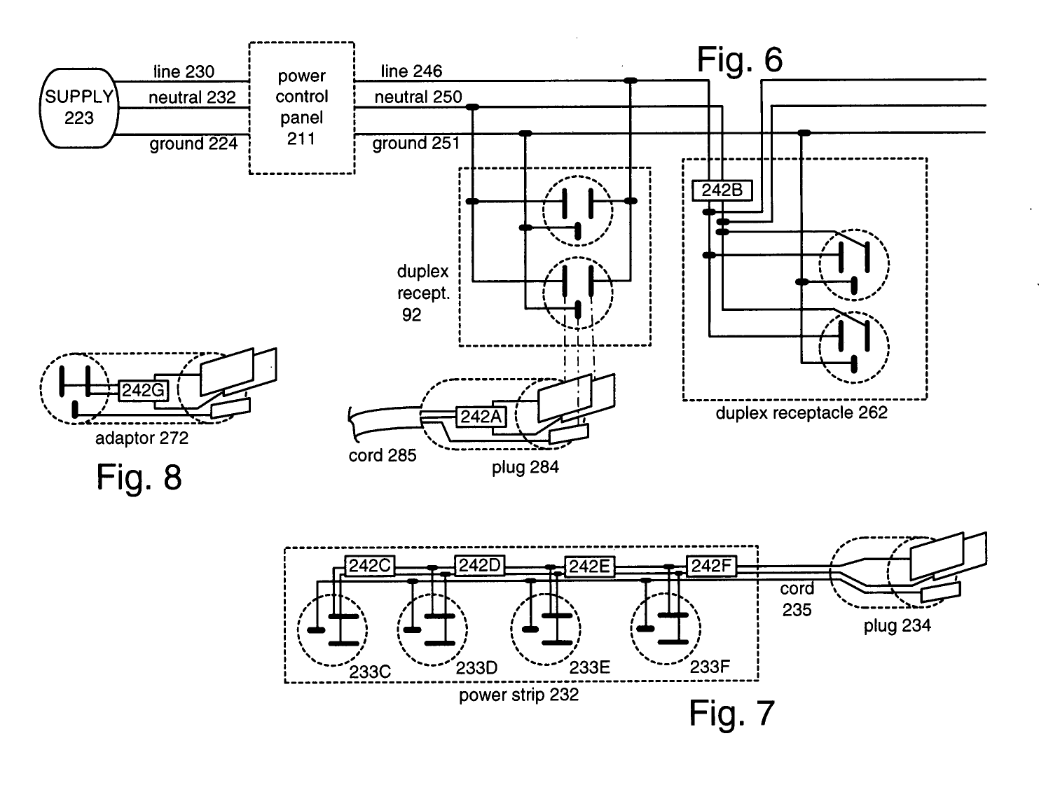

FIG. 6 shows thermally protected GFCI 242 used in receptacle 262 and in plug 284. Plug 284 has a face with hot and neutral blades and a ground prong. Inside the body of plug 284, GFCI 242A is coupled between the hot and neutral blades and cord 285. GFCI 242A operates in similar manner as GFCI 242 of FIG. 4.

Receptacle 262 provides current from line conductor 246 and neutral conductor 250 to GFCI 242B. The output of GFCI 242B is provided to the two outlets of receptacle 262 and to downstream devices. GFCI 242B operates in similar manner as GFCI 242 of FIG. 4.

FIG. 7 shows thermally protected GFCI 242 used in a four-outlet power strip. Conventional plug 234 is coupled to cord 235. The line and neutral conductors from cord 235 are provided to GFCI 242F. The output line and neutral conductors from GFCI 242F are provided as input to GFCI 242E. The output line and neutral conductors from GFCI 242E are provided as input to GFCI 242D. The output line and neutral conductors from GFCI 242D are provided as input to GFCI 242C. GFCIs 242C, 242D, 242E, 242F operate in similar manner as GFCI 242 of FIG. 4. The outputs of each GFCI are provided to a respective outlet.

The number of outlets is not crucial, that is, any number of outlets may be in the power strip.

In a variation, only one thermally protected GFCI is used for all of the outlets of the power strip.

FIG. 8 shows thermally protected GFCI 242 used in receptacle adaptor 272. One face of adaptor 272 has a plug with two blades and a ground prong, for insertion in a conventional wall receptacle. The other face of adaptor 272 has a receptacle for receiving the blades and prong of a plug from an appliance or other load. Inside the body of adaptor 272 is GFCI 242G, between the line and neutral conductors running from the plug face to the receptacle face. GFCI 242G operates in similar manner as GFCI 242 of FIG. 4.

Another embodiment of a thermally protected GFCI will now be discussed.

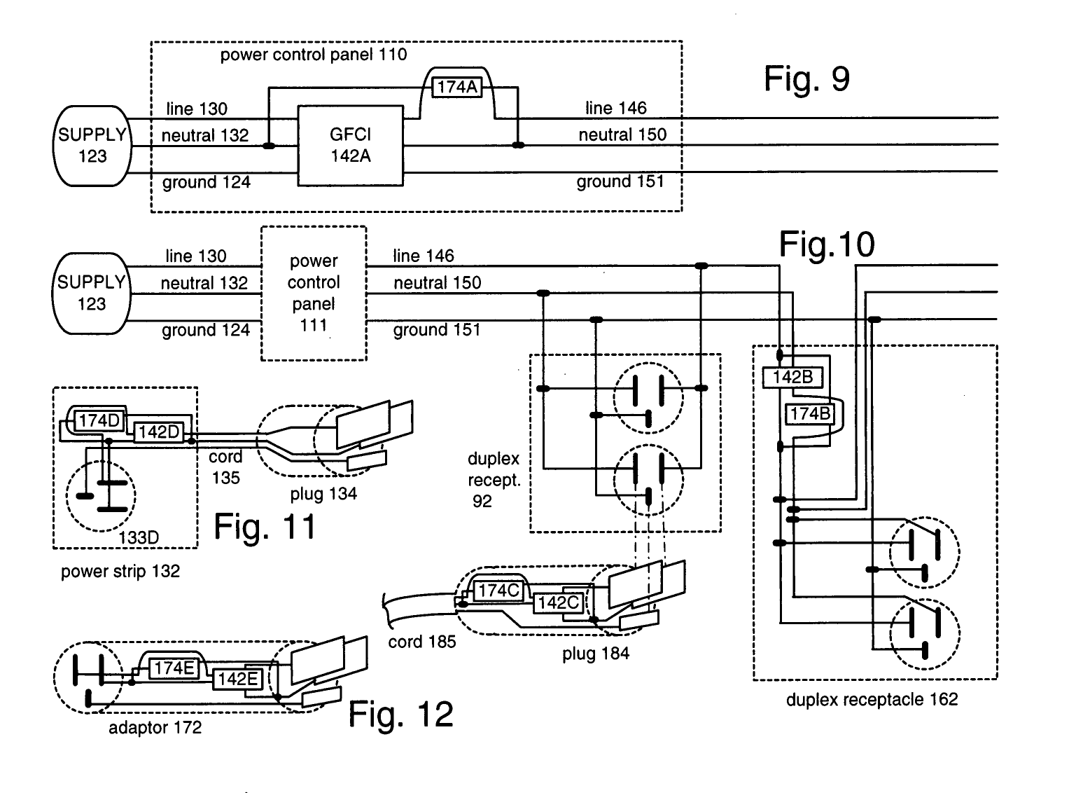

FIG. 9 shows power supply 123 connected to power control panel 110, also referred to as circuit breaker 110, which in turn is connected to receptacles (not shown). Power control panel 110 includes ground fault circuit interrupter (GFCI) 142A. Line conductor 130, neutral conductor 132 and ground conductor 124 are each connected between power supply 123 and GFCI 142A. GFCI 142A measures the current difference between line conductor 130 and neutral conductor 132 in a conventional manner, and when this exceeds a predetermined threshold such as 5-30 mA, interrupts the current flow. Line conductor 146, neutral conductor 150 and ground conductor 151 are on the output (downstream) side of GFCI 142A.

Thermal detector 174 is connected to neutral conductor 132 and neutral conductor 150. Line conductor 146 is configured to be in close physical proximity to thermal detector 174, but does not have electrical contact with thermal detector 174.

Heat flows to thermal detector 174 via three paths. A first path is through conductive contact with neutral conductors 132, 150. A second path is via radiation from line conductor 146. A third path is through the ambient temperature inside power control panel 110.

Thermal detector 174 may be any suitable thermal detector, such as a resettable or momentary contact bimetal, thermal reed switch or NTC resistor. The bimetal in its normal open state does not have current passing therethrough and does not affect the operation of GFCI 142A. When the temperature sensed by bimetal 174 reaches a predetermined threshold, such as a temperature in the range 75° C.-200° C., the bimetal snaps closed, diverting part of the current path around GFCI 142A, causing GFCI 142A to interrupt current to the load and downstream elements.

In a modification (not shown), another thermal detector is connected between line conductor 130 and line conductor 146, and is placed so that neutral conductor 150 generally surrounds the additional thermal detector. The additional thermal detector enables monitoring of the temperature at more points.

FIG. 10 shows the alternative thermally protected GFCI used in receptacle 162 and in plug 184.

Duplex receptacle 162 provides current from line conductor 146 and neutral conductor 150 to GFCI 174B. The output of GFCI 174B is provided to the two receptacles of duplex receptacle 262 and to downstream devices. Thermal detector 174B is arranged in similar manner relative to GFCI 142B as thermal detector 174A of FIG. 9.

Plug 184 has a face with hot and neutral blades and a ground prong. Inside the body of plug 184, GFCI 142C is coupled between the hot and neutral blades and cord 185, with thermal detector 174C arranged in similar manner as thermal detector 174A of FIG. 9.

FIG. 11 shows the alternative thermally protected GFCI used in a one-receptacle power strip. Conventional plug 134 is coupled to cord 135. The line and neutral conductors from cord 135 are provided to GFCI 142D. The output line and neutral conductors from GFCI 142D are provided to a receptacle. Thermal detector 174D is arranged in similar manner relative to GFCI 142D as thermal detector 174A of FIG. 9.

The number of receptacles is not crucial, that is, any number of receptacles may be in the power strip. The power strip may have one thermally protected GFCI per receptacle, or one thermally protected GFCI for the entire power strip.

FIG. 12 shows the alternative thermally protected GFCI used in receptacle adaptor 172. One face of adaptor 172 has a plug with two blades and a ground prong, for insertion in a conventional wall receptacle. The other face of adaptor 172 has a receptacle for receiving the blades and prong of a plug from an appliance or other load. Inside the body of adaptor 172 is GFCI 142E, between the line and neutral conductors running from the plug face to the receptacle face. Thermal detector 174E is arranged in similar manner relative to GFCI 142E as thermal detector 174A of FIG. 9.

U.S. Pat. No. 5,673,360 (Scripps) shows a portable humidifier with a bimetal thermal sensor. The thermal sensor is configured in a circuit with the GFCI between the load hot and load neutral. When the temperature at the overheat sensor rises above a predetermined level, the overheat sensor causes a transistor to close, by physically deforming to an open position, opening the electrical connection, which in turn causes another transistor to open, which directs the current through a resistor, which in turn causes a current imbalance in the GFCI. The GFCI senses the current imbalance in the line and neutral connections and trips.

U.S. Pat. No. 4,737,0769 (Masot) is directed to a temperature sensor mounted at an electrical outlet receptacle. When the temperature at the thermal sensor rises above a predetermined level, it sends a signal to a converter apparatus which is configured to send a signal through the circuit to a “short circuit or controlled overload device”. The resulting short circuit or overload is detected by a circuit breaker box, which then trips. In another embodiment, the signal is sent from the converter apparatus to the short circuit or controlled overload device via RF signal.

Although illustrative embodiments of the present invention, and various modifications thereof, have been described in detail herein with reference to the accompanying drawings, it is to be understood that the invention is not limited to these precise embodiments and the described modifications, and that various changes and further modifications may be effected therein by one skilled in the art without departing from the scope or spirit of the invention as defined in the appended claims.

What is claimed is:

1. An electrical device having thermal overload protection, comprising:
a current difference detector for measuring the difference in current between a line conductor and a neutral conductor,
a control circuit for preventing current flow on the line and neutral conductors when the measured current differences exceeds a current difference threshold, and
a temperature detection circuit for detecting a temperature of at least one of the line and neutral conductors and for causing a current difference exceeding the current difference threshold when the detected temperature exceeds a temperature threshold.

2. The electrical device of claim 1, wherein the electrical device is a circuit breaker.

3. The electrical device of claim 1, wherein the electrical device is an electrical receptacle.

4. The electrical device of claim 1, wherein the electrical device is an electrical plug.

5. The electrical device of claim 1, wherein the electrical device is a power strip.

6. The electrical device of claim 1, wherein the electrical device is a receptacle adaptor.

7. The electrical device of claim 1, wherein the temperature detection circuit includes at least one bimetal.

8. The electrical device of claim 1, wherein the temperature detection circuit resets to not causing a current difference when the detected temperature falls below the temperature threshold.

9. The electrical device of claim 1, wherein the current difference detector and the control circuit are inside a ground fault circuit interrupter (GFCI) and the temperature detection circuit is inside the GFCI.

10. The electrical device of claim 1, wherein the current difference detector and the control circuit are inside a ground fault circuit interrupter (GFCI) and the temperature detection circuit is outside the GFCI.

11. A method of providing thermal overload protection in an electrical device, comprising:
measuring the difference in current between a line conductor and a neutral conductor,
preventing current flow on the line and neutral conductors when the measured current differences exceeds a current difference threshold,
detecting a temperature of at least one of the line and neutral conductors, and
causing a current difference exceeding the current difference threshold when the detected temperature exceeds a temperature threshold.

12. The method of claim 11, wherein the electrical device is a circuit breaker.

13. The method of claim 11, wherein the electrical device is an electrical receptacle.

14. The method of claim 11, wherein the electrical device is an electrical plug.

15. The method of claim 11, wherein the electrical device is a power strip.

16. The method of claim 11, wherein the electrical device is a receptacle adaptor.

17. The method of claim 11, wherein the temperature detecting is performed by a bimetal.

18. The method of claim 11, wherein when the detected temperature falls below the temperature threshold, the causing of the current difference is terminated.

19. The method of claim 11, wherein measuring the current difference and preventing current flow are performed by a ground fault circuit interrupter (GFCI), and detecting the temperature and causing the current difference are also performed by the GFCI.

20. The method of claim 11, wherein measuring the current difference and preventing current flow are performed by a ground fault circuit interrupter (GFCI), and detecting the temperature and causing the current difference are performed external to the GFCI.
